(19) United States
(12) Patent Application Publication
(10) Pub. No.: US 2008/0241527 A1
(43) Pub. Date: Oct. 2, 2008

(54) ABRADABLE AND ANTI-ENCRUSTATION COATING FOR ROTATING FLUID MACHINES

(76) Inventors: Marco De Iaco, Florence (IT); Riccardo Paoletti, Florence (IT); Alessio Bandini, Sesto Florentinio (IT); Leonardo Pieri, Florence (IT)

Correspondence Address: General Electric Company;Global Patent Operation, 187 Danbury Road, Suite 204, Wilton, CT, 06897-4122, US

(21) Appl. No.: 12/049,593

(22) Filed: Mar. 17, 2008

(30) Foreign Application Priority Data
Mar. 30, 2007 (IT) MI2007A000665

(51) Int. Cl. B32B 15/08; B05D 1/36

(52) U.S. Cl. 428/339; 428/421; 427/9

(57) ABSTRACT

An abradable and anti-encrustation coating is described for a rotating fluid machine (10) of the type comprising a casing (12), in which a shaft (14) equipped with at least one rotor (16) having a series of circumferential vanes (18) is rotatingly assembled and at least one diffuser (20) integral with the casing (12). The outer edge of each circumferential vane (18) faces an annular surface portion (28) of the diffuser (20). The annular surface portion (28) of the diffuser (20) is at least partially covered with a coating which can be abraded by the outer edge of each circumferential vane (18), said abradable coating comprising of a first lower metal-based coating layer (30), applied on the annular surface portion (28) of the diffuser (20), and a second upper polymer-based coating layer (32), applied on the first lower metal-based coating layer (30).

### BACKGROUND OF THE INVENTION

1. Field of the Invention

The present invention relates to an abradable and anti-encrustation coating for rotating fluid machines, in particular but not exclusively for centrifugal compressors with an open 3D impeller and integral reducer.

2. Description of the Related Art

As is known, a compressor is a machine capable of raising the pressure of a compressible fluid (gas) with the use of mechanical energy. Among the various types of compressors used in process plants on an industrial scale, so-called centrifugal compressors can be mentioned, in which the energy to the gas is supplied in the form of centrifugal acceleration due to the rotation, generally driven by a driver (electric motor or vapour turbine), of an organ called rotor or impeller.

Centrifugal compressors can be equipped with a single rotor, in the so-called single-stage configuration, or several impellers arranged in series, in this case being called multistage compressors. More specifically, each stage of a centrifugal compressor normally includes of a suction duct for the gas to be compressed, an impeller, which is capable of supplying kinetic energy to the gas, and a diffuser, whose function is to convert the kinetic energy of the gas leaving the impeller into pressure energy.

In centrifugal compressors installed in petrochemical process plants, gases are often treated, which can contain various kinds of contaminating agents. These contaminating agents can influence the performances of the compressor, giving rise to encrustation and/or corrosion processes especially in the presence of particular metal-based coating films applied on some parts of the compressor itself.

In order to avoid possible interferences between the impeller and the relative fixed diffuser, in particular during the start-up phase of the compressor, at the same time maintaining minimum tolerances between the parts for a better performance of the compressor itself, the application of an abradable coating on the portion of the diffuser in contact with the vanes of the impeller is in fact envisaged. After a more or less prolonged use of the compressor and abrasion caused by the gas due to the rotation of the vanes, however, this type of coating, normally including of aluminum powder and polyester, has a rough surface which facilitates the formation of encrustations, even more evident and diffused in the presence of gas containing contaminating agents.

Furthermore, certain contaminating agents present in the gas can also cause the partial or complete detachment of the abradable coating film, as a result of crystallization processes of the gas itself inside the porosities of the aluminum-based film, with the risk of causing possible damage, also serious, to the components of the compressor.

In compressors coated with abradable films of the known type which process gas with a high content of contaminating agents, it is therefore necessary to effect periodic maintenance operations for the cleaning and removal of the encrustations, and also for a possible restoration of the coating film should it become detached from the surface, generally metallic, on which it is to be applied.

This requires frequent and prolonged machine stoppage times which can jeopardize the good functioning of the compressor and whole plant in which it is inserted.

An objective of the present invention is therefore to solve the problems of the abradable coatings according to the known art, by providing an abradable coating for rotating fluid machines, in particular but not exclusively for centrifugal compressors which process gas containing contaminating agents, which limits the formation of encrustations on its surface as much as possible, thus improving the performances of the machine.

Another objective of the invention is to provide an abradable coating for rotating fluid machines which prevents the detachment, also partial, of the coating itself from the metallic surface of the machine on which it is applied, also in the presence of particularly aggressive contaminating agents, so as to reduce the number of maintenance interventions to be effected on the machine.

A further objective of the invention is to provide a coating for rotating fluid machines which keeps its abradable characteristics unaltered with respect to the coatings of the known type currently adopted.

### BRIEF SUMMARY OF THE INVENTION

These objectives according to the present invention and others appreciated by those of ordinary skill in the applicable arts are achieved by providing an abradable and anti-encrustation coating for rotating fluid machines, in particular but not exclusively for centrifugal compressors which process gases containing contaminating agents.

### BRIEF DESCRIPTION OF THE DRAWINGS

The characteristics and advantages of an abradable and anti-encrustation coating for rotating fluid machines according to the present invention will appear more evident from the following illustrative and non-limiting description, referring to the enclosed schematic drawings in which:

FIG. 1 is a raised sectional side view of a centrifugal compressor equipped with an abradable and anti-encrustation coating according to the pre-sent invention;

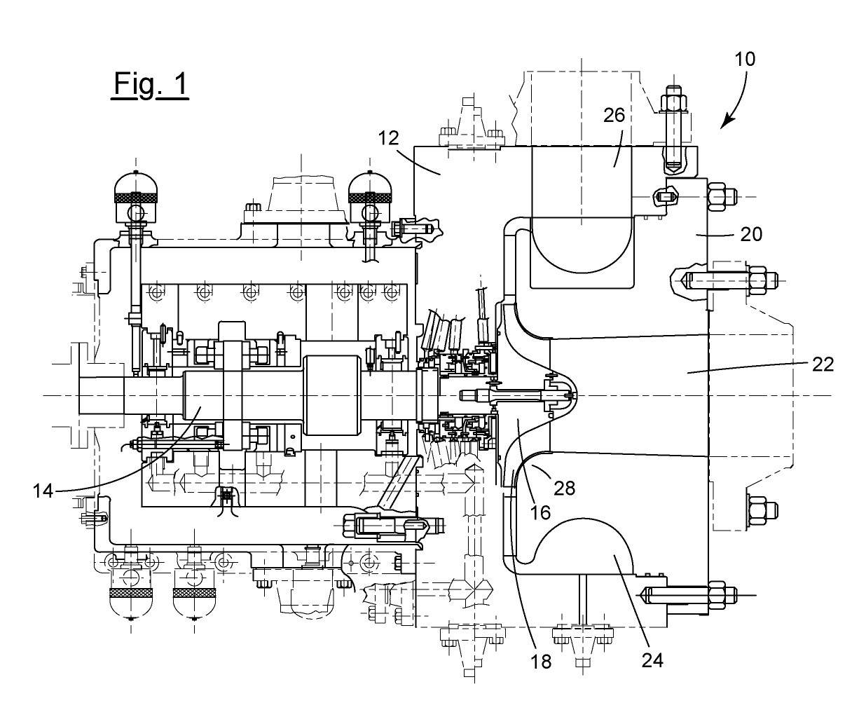

FIG. 2 is an enlarged sectional view which shows in detail the portion of the compressor of FIG. 1 on which the abradable and anti-encrustation coating according to the present invention is applied;

FIG. 3 is a plan view of the portion of the compressor of FIG. 1 on which the abradable and anti-encrustation coating according to the present invention is applied; and

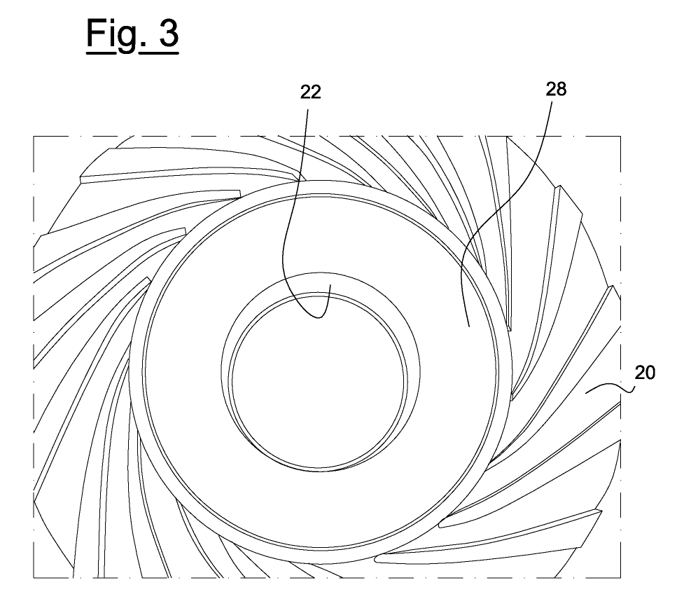

FIG. 4 is a highly enlarged sectional view of an application example of the abradable and anti-encrustation coating according to the present invention.

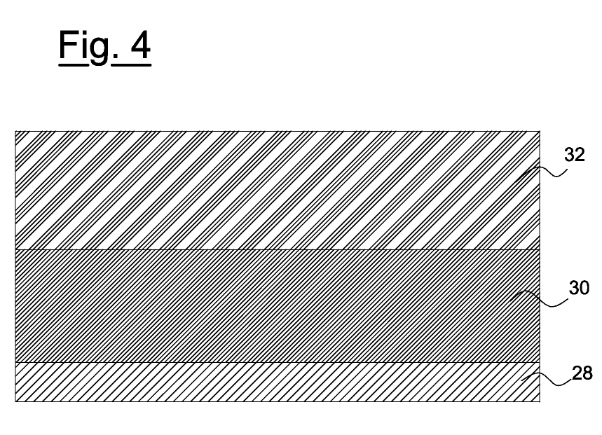

### DETAILED DESCRIPTION OF THE PREFERRED EMBODIMENTS

With reference to the figures, these show a generic centrifugal compressor, of the single-stage type, indicated as a whole with the reference number 10. The compressor 10 comprises a casing or stator 12 in which a shaft 14 is rotatingly assembled, equipped at one of its ends, with a rotor 16, in turn equipped with a series of circumferential vanes 18 having a substantially radial development.

A diffuser 20, which defines an axial duct 22, generally have a truncated-conical form, is made integral with the casing 12, in correspondence with the rotor 16, for the suction of the gas. On the diffuser 20 there is also a supply chamber 24, having a toroidal form, for the pressurized gas leaving the rotor 16, said supply chamber 24 sending the compressed gas towards a radial outlet duct 26.

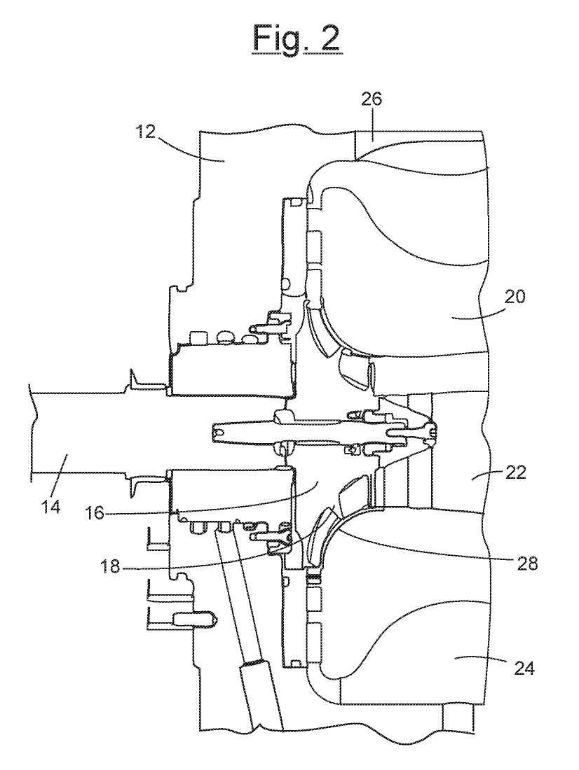

In the embodiment illustrated, the vanes 18 of the rotor 16 have an outer edge with a curved profile which faces a corresponding curved profile obtained on an annular surface portion 28 of the diffuser 20 in contact with the rotor 16 itself, as can be observed in detail in FIG. 2.

As the distance between the moveable vanes 18 and the fixed annular surface portion 28 is reduced to the minimum for a better performance of the compressor 10 and to prevent interference phenomena between the rotor 16 and the diffuser 20, said annular surface portion 28 is at least partially covered with a coating made with a material which can be abraded on the part of the outer edge of the vanes 18, especially in the start-up phase of the compressor 10 or in the presence of vibrations of a significant entity.

According to the invention, said coating of abradable material includes of a first metal-based coating layer 30, or lower layer, applied on the surface of the annular portion 28 of the diffuser 20, and a second polymer-based coating layer 32, or upper layer, applied on the first metal-based coating layer 30.

The thickness of the upper polymer-based coating layer 32 preferably ranges from 1 mm to 1.5 mm, with a particularly preferred thickness value of about 1.2 mm. The thickness of the first metal-based coating layer 30, on the other hand, can vary according to the manufacturing tolerances of the compressor 10, i.e. on the basis of the distance between the vanes 18 of the rotor 16 and the annular portion 28 of the diffuser 20. On the basis of experimental tests carried out on compressors having components with predefined dimensions, it was possible to define an average thickness ranging from 1 mm to about 1.5 mm for said lower coating layer.

Although numerous metal-based and polymer-based materials can be used for the first coating layer 30 and the second coating layer 32, respectively, from experimental tests it has been found that a particularly preferred material for the first coating layer 30 can include of an aluminum powder at 99%, anchored to the metallic substrate by means of a nickel and aluminum (NiAl) alloy. In the specific embodiment example illustrated herein, said material for the first coating layer 30 was obtained by combining known coatings with the commercial name “Metco 54NS” and “Metco 450” (anchoring agent) produced by Sulzer Metco.

For the second coating layer 32, which forms the abradable portion of the coating applied to the surface of the annular portion 28 of the diffuser 20, a material known with the trade-name “Halar® ECTFE 6014”, produced by Solvay, was selected in the specific embodiment example illustrated herein. This material is a high-performance thermoplastic fluoropolymer (ethylene-chlorotrifluoroethylene), which can be easily applied as a particularly smooth coating. This coating has excellent insulating properties, resistance to atmospheric agents and radiations. It also has good adhesion to the underlying coating, is easy to clean and has chemical resistance to most acids, bases and industrial solvents. At the same time, it guarantees sufficient abradable characteristics on the part of the vanes 18 of the rotor 16.

Operationally, after defining and insulating the portion 28 of the diffuser 20 on which the abradable coating according to the invention is to be applied, the application is effected, on the basis of known methods, of the first metal-based coating layer 30. Once the thickness of the coating layer 30 applied has been measured, verifying that it corresponds to the thickness envisaged on the basis of the tolerances between the rotor 16 and diffuser 20, the second polymer-based coating layer 32 is applied.

A method adopted for the application of the second coating layer 32, for example, corresponds to the following procedure:
visual control of the first aluminum coating 30, in order to verify the absence of impact and damage;
thermal degreasing in an oven at a temperature of about 300° C. and for about 30 minutes;
sandblasting, with aluminum oxide at a maximum pressure of 4 bar, of the aluminum layer 30 previously applied, covering the areas to be protected with a strip of paper and subsequent blowing with compressed air;
application in layers, after interfacing with primers, of the abradable and anti-encrustation coating layer 32 with a fluid bed electrostatic gun onto the piece preheated in an oven, at a temperature of about 270° C. and for about 30 minutes; and
cleaning and final controls of the thickness and porosity with a spessimeter for non-magnetic bases and scintillograph at 5,000 Volts with direct current, respectively.

At this point, it is possible to assemble the diffuser 20 equipped with the abradable coating according to the invention.

The experimental tests effected showed that this coating has a very low surface roughness (<0.2 μm), measured therefore on the upper polymer-based coating layer 32. At the same time, the lower layer 30 has significant adhesion values to the substrate of the diffuser 20, resisting stress value of over 40 MPa.

These combined characteristics demonstrate the anti-encrustation properties of the coating according to the invention, which maintains a limited surface roughness also after the envisaged abrasion on the part of the rotor vanes. Furthermore, the resistance to contaminating agents of the upper layer avoids any possibility of even partial detachment of the underlying metallic layer, protecting it, with evident advantages in terms of durability and efficiency of the compressor.

It can thus be seen that the abradable and anti-encrustation coating for rotating fluid machines, in particular for centrifugal compressors which process gases containing contaminating agents, according to the present invention, achieves the objectives indicated above. The abradable and anti-encrustation coating for centrifugal compressors of the present invention thus conceived can in any case undergo numerous modifications and variants, all included in the same inventive concept. The protection scope of the invention is therefore defined by the enclosed claims.

1. An abradable and anti-encrustation coating for a rotating fluid machine (10) of the type comprising a casing (12), in which a shaft (14) equipped with at least one rotor (16) having a series of circumferential vanes (18) is rotatingly assembled and at least one diffuser (20) integral with said casing (12), the outer edge of each circumferential vane (18) facing an annular surface portion (28) of said diffuser (20), said annular surface portion (28) of said diffuser (20) being at least partially covered with a coating which can be abraded by said outer edge of each circumferential vane (18), wherein said abradable coating comprises of a first lower metal-based coating layer (30), applied on said annular surface portion (28) of said diffuser (20), and a second upper polymer-based coating layer (32), applied on said first lower metal-based coating layer (30).

2. The abradable and anti-encrustation coating according to claim 1, wherein the thickness of said upper polymer-based coating layer (32) ranges from 1 mm to 1.5 mm.

3. The abradable and anti-encrustation coating according to claim 2, wherein the thickness of said upper polymer-based coating layer (32) is about 1.2 mm.

4. The abradable and anti-encrustation coating according to claim 1, wherein the thickness of said lower metal-based coating layer (30) ranges from 1 mm to 1.5 mm.

5. The abradable and anti-encrustation coating according to claim 1, wherein said lower metal-based coating layer (30) comprises of a base of powder aluminum at 99% and a nickel and aluminum (NiAl) binder.

6. The abradable and anti-encrustation coating according to claim 1, wherein said upper polymer-based coating layer (32) is a thermoplastic fluoro-polymer.

7. The abradable and anti-encrustation coating according to claim 6, wherein said thermoplastic fluoropolymer is ethylene-chloro-trifluoroethylene.

8. A method for the application of an abradable and anti-encrustation coating on a rotating fluid machine (10) of the type comprising a casing (12), in which a shaft (14) equipped with at least one rotor (16) having a series of circumferential vanes (18) is rotatingly assembled, and at least one diffuser (20) integral with said casing (12), is, the outer edge of each circumferential vane (18) facing an annular surface portion (28) of said diffuser (20), the method comprising the following phases:
insulating said annular surface portion (28) of said diffuser (20) on which said abradable and anti-encrustation coating is to be applied;
applying a first metal-based coating layer (30) on said portion of said diffuser (20);
measuring the thickness of said first metal-based coating layer (30);
verifying that said thickness of said first metal-based coating layer (30) corresponds to the thickness envisaged on the basis of the tolerances between said rotor (16) and said diffuser (20);
applying a second polymer-based coating layer (32) on said first metal-based coating layer (30).

9. The method according to claim 8, wherein said second polymer-based coating layer (32) is applied according to the following phases:
visual control of said first metal-based coating layer (30) in order to verify the absence of impact and damage;
thermal degreasing in an oven at a temperature of about 300° C. and for about 30 minutes;
sandblasting, with aluminum oxide at a maximum pressure of 4 bar, of said first coating layer (30), covering the areas to be protected with a strip of paper and subsequent blowing with compressed air;
application in layers, after interfacing with primers, of said second polymer-based coating layer (32) with a fluid bed electrostatic gun onto the piece preheated in an oven, at a temperature of about 270° C. and for about 30 minutes; and
cleaning and final controls of the thickness and porosity with a spessimeter for non-magnetic bases and scintillograph at 5,000 Volts with direct current, respectively.

10. The method according to claim 8, wherein said lower metal-based coating layer (30) comprises of a base of aluminum powder at 99% and a nickel and aluminum (NiAl) binder.

11. The method according to claim 8, wherein said upper polymer-based coating layer (32) is a thermoplastic fluoropolymer.

12. The method according to claim 11, wherein said thermoplastic fluoropolymer is ethylene-chloro-trifluoroethylene.
